(19) United States
(12) Patent Application Publication
(10) Pub. No.: US 2016/0219974 A1
(43) Pub. Date: Aug. 4, 2016

(54) MOULD FOR PRODUCING SOLES OF FOOTWEAR AND SOLE PRODUCED WITH SAID MOULD

(71) Applicant: DESARROLLO INTEGRAL DEL MOLDE, S.L., Pamplona (Navarra) (ES)

(72) Inventor: Jose Maria IZQUIETA ANAUT, Pamplona, Navarra (ES)

(73) Assignee: Desarrollo Integral del Molde, S.L., Pamplona, Navarra (ES)

(21) Appl. No.: 14/917,653

(22) PCT Filed: Sep. 18, 2013
(86) PCT No.: PCT/ES2013/070649

§ 371 Date: Mar. 9, 2016

(51) Int. Cl. A43B 13/18; B29D 35/12

(52) U.S. Cl. CPC A43B 13/181; B29D 35/122

(57) ABSTRACT

The invention relates to a mould for producing soles of footwear, and to the sole produced by said mould, which includes a moulding surface consisting of a plurality of recesses and projections forming protuberances, inside the sole, that compress and bend during the footstep, where the projections are inclined in relation to the surface of the footstep, said projections being designed and separated such that they are formed only by moulding, since it is not possible to insert a machining tool in the separation between said projections nor is it possible to machine the recesses between the projections.

### TECHNICAL FIELD OF THE INVENTION

The present invention falls within the field of production of soles for footwear.

In particular, the invention relates to a mould for producing soles for footwear whose moulding surface forms the inside of said sole for footwear, achieving greater comfort for the user who wears it.

Likewise, the invention relates to a sole for footwear produced with the mould described in the present invention.

### BACKGROUND OF THE INVENTION

There is known moulding of soles, i.e., the lower portion of footwear, from rubber or thermoplastic materials, with the aim of providing footwear having as anatomical as possible support for the user's foot, trying to avoid damaging the feet through the deformation or compression they experience every time the user's weight is exerted on the footwear, which strikes the ground repeatedly when walking or running.

This is why so-called ‘shock-proof’ soles have been designed, which are usually characterized by having different shock absorption areas or zones in accordance with the anatomy and physiology of the user's foot. To this end, there are commonly provided for soles for footwear having zones of greater compressibility and/or softness in the foot areas which experience the direct impact when the footwear is placed on the ground on advancing.

For example, patent EP 2366300, published on 21 Sep. 2011, relates to a lower portion of footwear consisting in a monolithic structure moulded in rubber or made of thermoplastic materials, wherein the outer surface of the sole consists of a series of transverse tubular profiles and its inside is designed with a discontinuous structure which supports the user's feet with a series of straight flanges or flaps separated by intermediate grooves.

The flaps are of two kinds and are disposed in an alternate manner. A first kind of flaps can be resiliently deformed, i.e., they can be selectively compressed in accordance with the force which the user's foot exerts on it. On the other hand, the flaps of the second kind ensure the sole will not collapse entirely under the feet's weight.

However, since the flaps are arranged at a right angle in relation to the bearing surface of the footwear, the foot bears perpendicularly on them, crushing them without taking full advantage of the resilient properties of the material of the flaps in order to achieve a much softer and comfortable support for the user's foot.

On the other hand, should it be desired to change the straight configuration of the known flaps to offer more comfort to the user's foot, this would entail making the profile followed by the inner face of the sole more complex. Therefore, it would be impossible to use the traditional surface machining tools, e.g., a mill, for producing the moulds of the sole since it is not possible with said tool to reach all the nooks and crannies of the profile to entirely shape the moulding surface.

Thus, it is necessary to overcome the aforementioned drawbacks, to be able to produce in a simple, effective and cheap manner a mould for forming a sole for footwear, as well as for said sole to entail greater comfort for the user wearing it. cl DESCRIPTION OF THE INVENTION

The present invention is established and characterised in the independent claims, while the dependent claims describe additional characteristics thereof.

The object of the present invention is a mould for producing soles for footwear, which includes a moulding surface consisting of a plurality of recesses and projections forming, inside the sole of the footwear to be moulded, protuberances which compress and bend during the footstep.

Likewise, the projections are disposed inclined in relation to the surface of the footstep of the sole to be moulded. Said projections are designed and separated from each other such that they are only formed by moulding, since it is not possible to insert a machining tool in the separation existing between said projections, nor is it possible either to undertake the machining of the recesses between the projections.

It is also an object of the present invention a sole for footwear formed using the aforementioned mould, inside of which protuberances are formed which compress and bend during the footstep, wherein the protuberances are disposed inclined in relation to the surface of the footstep.

As can be seen, the moulding surface comprised of inclined projections separated by recesses is able to form, inside the sole, the protuberances in an inclined manner in relation to the surface of the footstep. Thus, when the user's foot bears on the sole, said protuberances compress at their upper portion. Since said protuberances are arranged in an inclined manner, instead of being crushed withstanding the weight of the user's foot, they bend and cushion the vertical force generated by said weight on the sole, a much softer and comfortable support being achieved.

### BRIEF DESCRIPTION OF THE DRAWINGS

This specification is supplemented with a set of drawings, illustrative of the preferred embodiment, and never limiting the invention.

FIG. 1 depicts a cross-sectional side view of a mould for producing soles for footwear.

FIG. 2 depicts a cross-sectional side view of a first embodiment of the protuberances of a sole for footwear produced using the mould of FIG. 1, wherein said protuberances are formed by an partition inclined in relation to the surface of the footstep.

FIG. 3 depicts a cross-sectional side view of a second embodiment of the protuberances of the sole for footwear produced using the mould of FIG. 1, wherein said protuberances are formed by a curved partition inclined in relation to the surface of the footstep.

FIG. 4 depicts a cross-sectional side view of a second embodiment of the protuberances of the sole for footwear produced using the mould of FIG. 1, wherein said protuberances are formed by an angular partition having a first straight portion and a second portion inclined in relation to the surface of the footstep.

FIG. 5 depicts a top view of a first embodiment of the orientation of the protuberances of FIG. 2, 3 or 4 on the sole for footwear produced using the mould of FIG. 1, wherein said protuberances extend parallel to the longitudinal axis of the sole.

FIG. 6 depicts a top view of a second embodiment of the orientation of the protuberances of FIG. 2, 3 or 4 on the sole for footwear produced using the mould of FIG. 1, wherein said protuberances extend transversely to the longitudinal axis of the sole.

FIG. 7 depicts a top view of a third embodiment of the orientation of the protuberances of FIG. 2, 3 or 4 on the sole for footwear produced using the mould of FIG. 1, wherein said protuberances extend obliquely to the longitudinal axis of the sole.

FIG. 8 depicts a top view of a fourth embodiment of the orientation of the protuberances of FIG. 2, 3 or 4 on the sole for footwear produced using the mould of FIG. 1, wherein said protuberances extend perpendicularly and obliquely to the longitudinal axis of the sole.

FIG. 9 depicts a top view of a fifth embodiment of the orientation of the protuberances of FIG. 2, 3 or 4 on the sole for footwear produced using the mould of FIG. 1, wherein a first group of said protuberances extends parallel and a second group perpendicularly to the longitudinal axis of the sole.

FIG. 10 depicts a top view of a sixth embodiment of the orientation of the protuberances of FIG. 2, 3 or 4 on the sole for footwear produced using the mould of FIG. 1, wherein a first group of said protuberances extends obliquely to the longitudinal axis of the sole and a second group perpendicularly to said first group.

FIG. 11 depicts a top view of a first embodiment of the layout of the protuberances of FIG. 2, 3 or 4 on the sole for footwear produced using the mould of FIG. 1, wherein the protuberances are formed in an arched manner.

FIG. 12 depicts a top view of a second embodiment of the layout of the protuberances of FIG. 2, 3 or 4 on the sole for footwear produced using the mould of FIG. 1, wherein the protuberances are formed in a corrugated manner.

FIG. 13 depicts a top view of a third embodiment of the layout of the protuberances of FIG. 2, 3 or 4 on the sole for footwear produced using the mould of FIG. 1, wherein the protuberances are formed in a crooked manner.

FIG. 14 depicts a top view of another embodiment of the layout of the protuberances of FIG. 2, 3 or 4 on the sole for footwear produced using the mould of FIG. 1, wherein protuberances formed in a crooked manner, on the centre of the sole, are combined with protuberances formed in a corrugated manner on the heel.

FIG. 15 depicts a top view of a sole for footwear, including any of the embodiments shown in FIGS. 5 to 14, wherein the protuberances are interrupted by intermediate notches and separated from the gluing zone of the sole by means of end notches.

FIG. 16 depicts a cross-sectional front view of the sole for footwear of FIG. 15.

### DETAILED EXPLANATION OF THE PREFERRED EMBODIMENT OF THE INVENTION

An embodiment of the invention is shown below with reference to the figures set out.

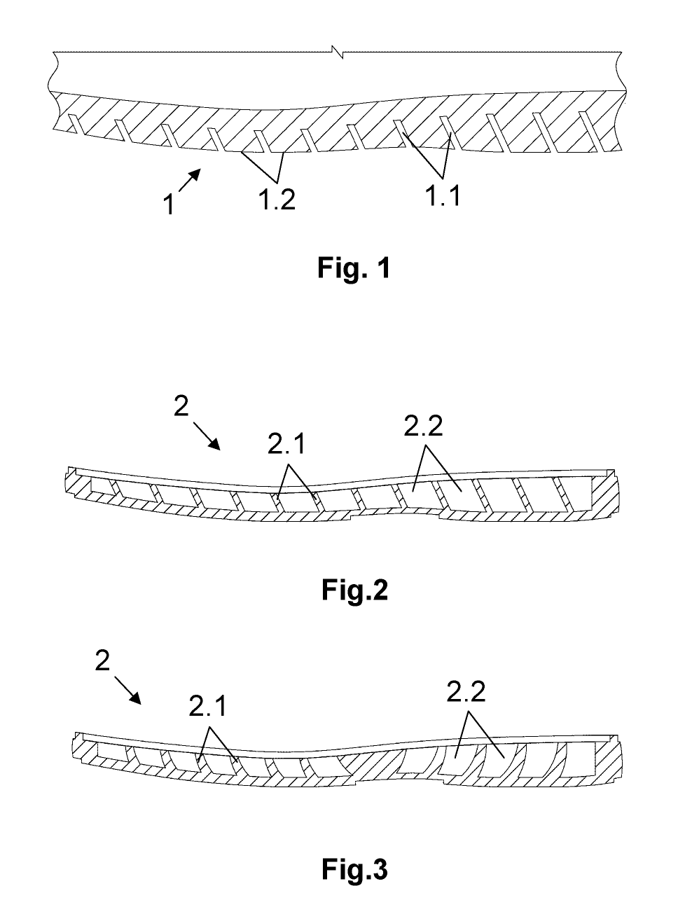

As shown in FIG. 1, the mould for producing soles for footwear includes a moulding surface (1) consisting of a plurality of recesses (1.1) and projections (1.2) forming, inside the sole (2), protuberances (2.1), seen in FIGS. 2, 3 and 4. Said protuberances (2.1) compress and bend during the footstep.

On the other hand, the projections (1.2) are arranged inclined in relation to the surface of the footstep. Said projections (1.2) are designed and separated from each other such that they may only be formed by moulding, by 3D printing preferably or by lost-wax casting.

As shown in FIG. 1, the preceding is due to the recesses (1.1) separating the projections (1.2) being very narrow and inclined, which do not allow the tool (not shown in the figures) of conventional surface machining means, e.g., a mill, to penetrate between two projections (1.2) and carries out the full machining of the corresponding recess (1.1).

The narrow recesses (1.1) of the moulding surface (1) match the inclined protuberances (2.1) formed by said moulding surface (1) inside the sole (2). Likewise, the projections (1.2) match notches (2.2), also narrow, formed in the sole (2).

Thus, it is possible to reproduce or copy exactly, inside the sole (2), the desired surface configuration which has been moulded on the moulding surface (1), a sole (2) for footwear being obtained (see FIGS. 2, 3 and 4), with the inside formed by protuberances (2.1), separated by notches (2.2), which compress and bend on taking a footstep.

As shown in FIG. 2, it is preferred that the recesses (1.1) of the moulding surface (1) form the protuberances (2.1) as a partition inclined in relation to the surface of the footstep.

In a second embodiment, seen in FIG. 3, the protuberances (2.1) are formed by the recesses (1.1) as a curved partition inclined in relation to the surface of the footstep.

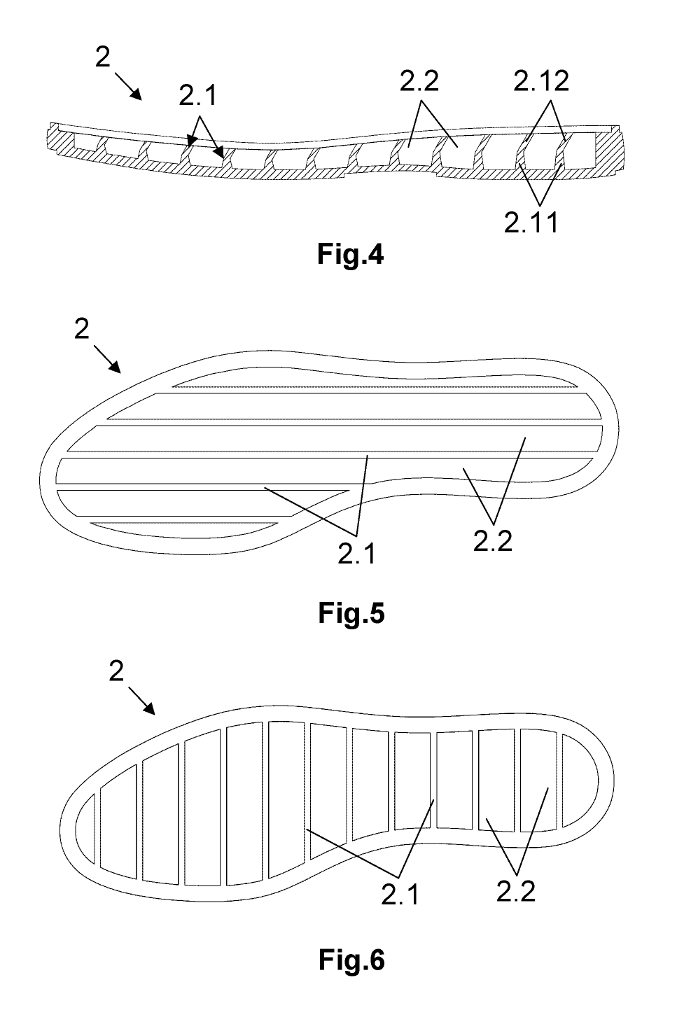

Likewise, FIG. 4 shows a third embodiment of the protuberances (2.1), wherein the latter have been formed by the recesses (1.1) of an angular partition having a first straight portion (2.11) and a second portion inclined (2.12) in relation to the surface of the footstep.

On the other hand, it is preferred that the recesses (1.1) and projections (1.2) extend parallel, transversely or obliquely in relation to the longitudinal axis of the imprint of the sole (2).

Thus, as shown in FIG. 5, in a first embodiment of orientation of the protuberances (2.1), they can remain extended parallel to the longitudinal axis of the sole (2).

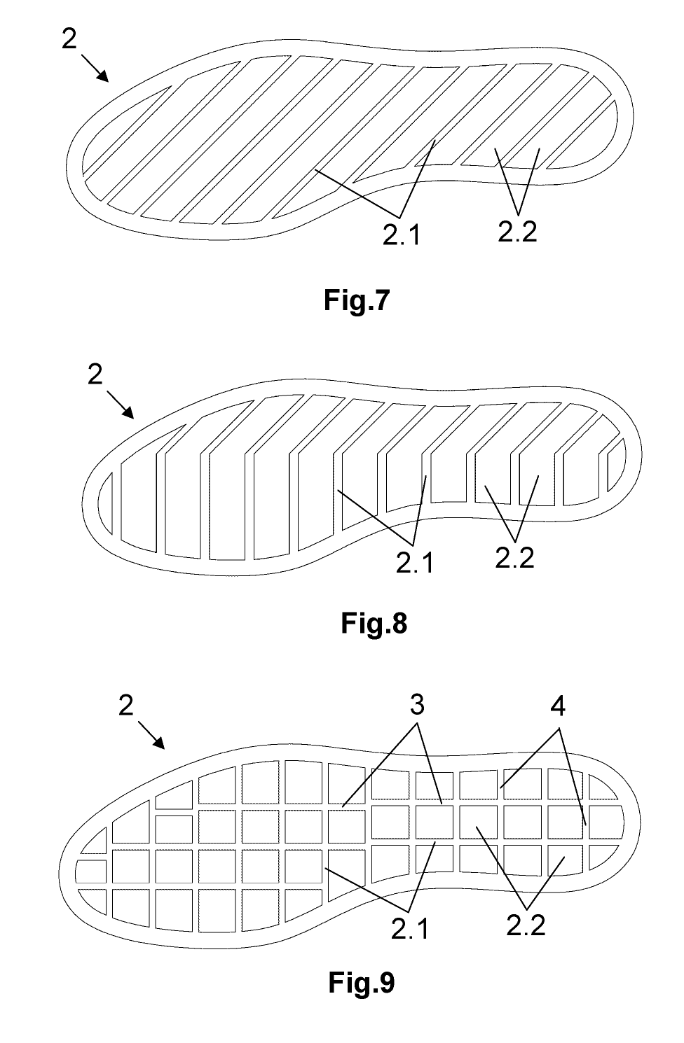

FIG. 6 shows a second embodiment of orientation of the protuberances (2.1), wherein the latter can remain extended transversely in relation to the longitudinal axis of the sole (2).

In a third embodiment of orientation of the protuberances (2.1), shown in FIG. 7, they can extend obliquely in relation to the longitudinal axis of the sole (2).

Likewise, the recesses (1.1) and projections (1.2) can extend, first, perpendicularly to the longitudinal axis of the imprint of the sole (2), and then, obliquely to said longitudinal axis.

In this case, a fourth embodiment is obtained of the orientation of the protuberances (2.1), seen in FIG. 8, wherein said protuberances (2.1) extend, first, perpendicularly to the longitudinal axis of the sole (2), and them, obliquely to said longitudinal axis.

On the other hand, the moulding surface (1) could be formed by a first and a second group of recesses (1.1) and projections (1.2), wherein said first group extends parallel to the longitudinal axis of the imprint of the sole (2) and the second group extends perpendicular to said longitudinal axis.

In this case, as shown in FIG. 9, a fifth embodiment is obtained of the orientation of the protuberances (2.1), wherein a first group (3) of said protuberances (2.1) extends parallel to the longitudinal axis of the sole (2) and a second group (4) extends perpendicularly to said longitudinal axis.

Likewise, the first group of recesses (1.1) and projections (1.2) of the moulding surface (1) can extend obliquely to the longitudinal axis of the imprint of the sole (2) and the second group can remain extended perpendicularly to the first group.

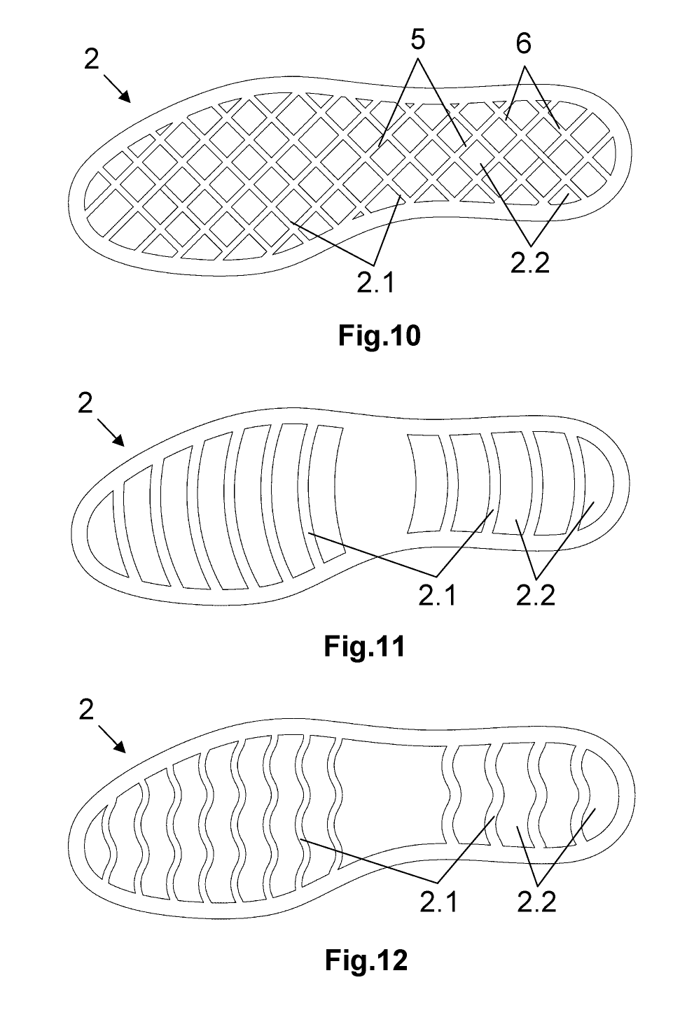

In this case, as shown in FIG. 10, a sixth embodiment is obtained of the orientation of the protuberances (2.1), wherein the first group (5) of said protuberances (2.1) extends obliquely to the longitudinal axis of the sole (2) and the second group (6) remains extended perpendicularly to said first group (5).

It can be understood that it is possible to obtain dissimilar embodiments of orientation of the protuberances (2.1) by combining the preceding embodiments in the forming of the different zones of bearing of the user's foot on the sole (2). For example, in the zone of the centre of the sole, the protuberances (2.1) can be extended obliquely in relation to the longitudinal axis of the sole (2), and in the heel zone, the protuberances (2.1) can be formed extended parallel to said longitudinal axis.

On the other hand, the recesses (1.1) and projections (1.2) of the moulding surface (1) can be formed in an arched, corrugated or crooked manner.

Thus, in a first embodiment of the layout of the protuberances (2.1), seen in FIG. 11, the recesses (1.1) and projections (1.2) form the protuberances (2.1) in an arched manner.

Likewise, in a second embodiment of the layout of the protuberances (2.1), as shown in FIG. 12, the protuberances (2.1) are formed in a corrugated manner.

And in a third embodiment of the layout of the protuberances (2.1) (see FIG. 13), the protuberances (2.1) are formed in a crooked manner.

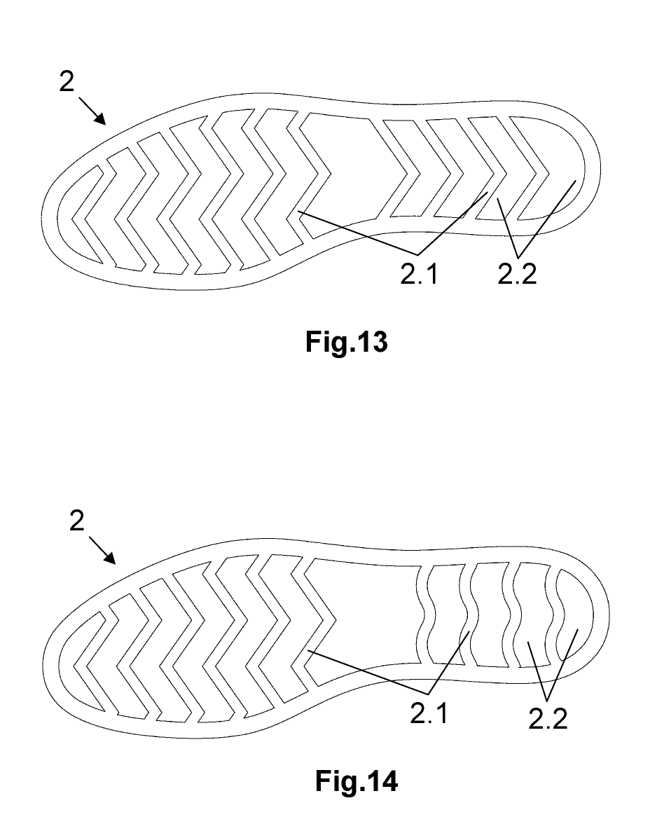

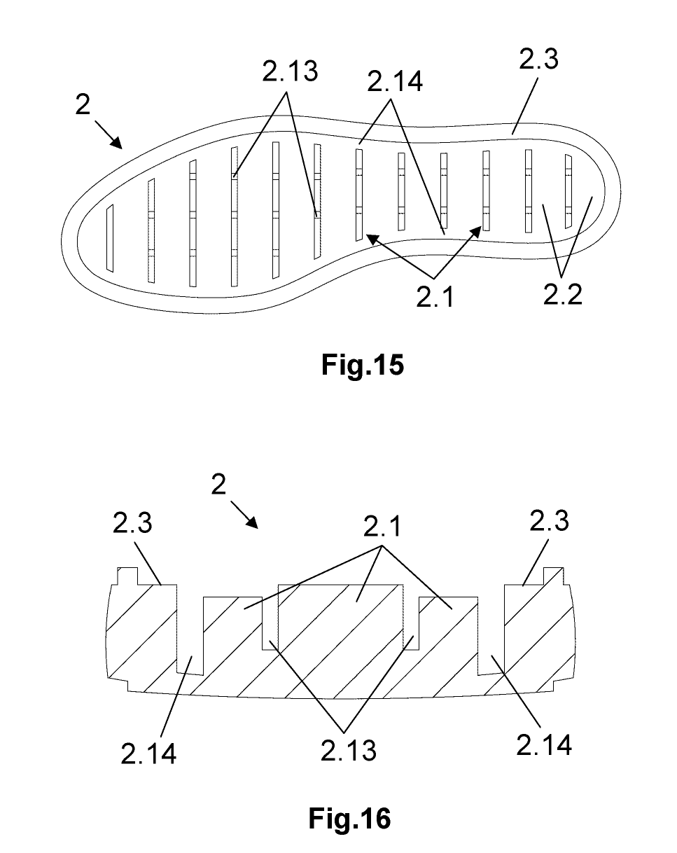

It is also possible to combine the previously described layout embodiments to form the different zones of bearing of the foot on said sole (2). For example (see FIG. 14), by drawing in a crooked manner the protuberances (2.1) made on the zone of the centre of the sole (2), and in a corrugated manner, those of the heel zone.

Likewise, it is possible to carry out any variant of combination of the different embodiments of orientation and layout of the protuberances (2.1) to form the different zones of bearing of the user's foot on the sole (2). The chosen combination will be reproduced, preferably by 3D printing, on the moulding surface (1), and the latter will be used to eventually produce the sole (2) of the footwear with the chosen combination as the inside.

On the other hand, in order to enhance the cushioning effect on the user's foot which bears on the sole (2) (see FIG. 15), it is preferred to interrupt the protuberances (2.1), along their length, with at least one intermediate notch (2.13).

Likewise, the protuberances (2.1) can be kept separate from the gluing zone (2.3) of the sole (2) by means of end notches (2.14), and thus, less resistance to cushioning is exerted.

As shown in FIG. 16, both the intermediate notches (2.13) and the end notches (2.14) can have a depth smaller or equal than the height of the protuberances (2.1), and can be made in combination with any of the previously described embodiments of orientation and layout of the protuberances (2.1).

Likewise, some or all of the protuberances (2.1), separated by the intermediate notches (2.13), can sit at a height lower than the gluing zone (2.3) of the sole (2).

1. A mould for producing soles for footwear, which includes a moulding surface (1) consisting of a plurality of recesses (1.1) and projections (1.2) forming inside the sole (2) protuberances (2.1) which compress and bend during the footstep, characterised in that the projections (1.2) are arranged inclined in relation to the surface of the footstep, said projections (1.2) being designed and separated from each other such that they are only formed by moulding, since it is not possible to insert a machining tool in the separation between said projections (1.2), or to machine of the recesses (1.1) between the projections (1.2).

2. A mould according to claim 1, wherein the moulding is by 3D printing or by lost-wax casting.

3. A mould according to claim 1, wherein the recesses (1.1) form the protuberances (2.1) inside the sole (2) as an inclined partition, or an inclined curved partition, or an angular partition having a first straight portion (2.11) and a second portion inclined (2.12) in relation to the surface of the footstep.

4. A mould according to claim 1, wherein the recesses (1.1) and projections (1.2) extend parallel, transversely or obliquely in relation to the longitudinal axis of the imprint of the sole (2).

5. A mould according to claim 3, wherein the recesses (1.1) and projections (1.2) extend parallel, transversely or obliquely in relation to the longitudinal axis of the imprint of the sole (2).

6. A mould according to claim 1, wherein a first group of recesses (1.1) and projections (1.2) extends parallel to the longitudinal axis of the imprint of the sole (2) and a second group of recesses (1.1) and projections (1.2) extends perpendicular to said longitudinal axis.

7. A mould according to claim 3, wherein a first group of recesses (1.1) and projections (1.2) extends parallel to the longitudinal axis of the imprint of the sole (2) and a second group of recesses (1.1) and projections (1.2) extends perpendicular to said longitudinal axis.

8. A mould according to claim 1, wherein a first group of recesses (1.1) and projections (1.2) extends obliquely to the longitudinal axis of the imprint of the sole (2) and a second group of recesses (1.1) and projections (1.2) extends perpendicularly to the first group.

9. A mould according to claim 3, wherein a first group of recesses (1.1) and projections (1.2) extends obliquely to the longitudinal axis of the imprint of the sole (2) and a second group of recesses (1.1) and projections (1.2) extends perpendicularly to the first group.

10. A mould according to any of claims 4, wherein the recesses (1.1) and projections (1.2) are formed in an arched, corrugated or crooked manner.

11. A mould according to any of claims 5, wherein the recesses (1.1) and projections (1.2) are formed in an arched, corrugated or crooked manner.

12. A mould according to any of claims 6, wherein the recesses (1.1) and projections (1.2) are formed in an arched, corrugated or crooked manner.

13. A mould according to any of claims 7, wherein the recesses (1.1) and projections (1.2) are formed in an arched, corrugated or crooked manner.

14. A mould according to any of claims 8, wherein the recesses (1.1) and projections (1.2) are formed in an arched, corrugated or crooked manner.

15. A mould according to any of claims 9, wherein the recesses (1.1) and projections (1.2) are formed in an arched, corrugated or crooked manner.

16. A sole for footwear inside of which protuberances are formed (2.1), separated by notches (2.2), which compress and bend during the footstep, the protuberances (2.1) being arranged inclined in relation to the surface of the footstep, characterised in that the protuberances (2.1) are formed by an inclined angular partition having a first straight portion (2.11) and a second portion inclined (2.12) in relation to the surface of the footstep.

17. A sole according to claim 16, wherein the protuberances (2.1) extend parallel, transversely or obliquely in relation to longitudinal axis of the sole (2).

18. A sole according to claim 16, wherein the protuberances (2.1) extend, first, perpendicularly to the longitudinal axis of the sole (2), and then, obliquely to said longitudinal axis.

19. A sole according to claim 16, wherein a first group (3) of protuberances (2.1) extends parallel to the longitudinal axis of the sole (2) and a second group (4) of protuberances (2.1) extends perpendicular to said longitudinal axis.

20. A sole according to claim 16, wherein a first group (5) of projections (1.2) extends obliquely to the longitudinal axis of the sole (2) and a second group (6) of protuberances (2.1) extends perpendicularly to the first group (5).

21. A sole according to claim 17, wherein the protuberances (2.1) are formed in an arched, corrugated or crooked manner.

22. A sole according to claim 18, wherein the protuberances (2.1) are formed in an arched, corrugated or crooked manner.

23. A sole according to claim 19, wherein the protuberances (2.1) are formed in an arched, corrugated or crooked manner.

24. A sole according to claim 20, wherein the protuberances (2.1) are formed in an arched, corrugated or crooked manner.

25. A sole according to claim 17, wherein the protuberances (2.1) are interrupted, along their length, by at least an intermediate notch (2.13), and/or are separated from a gluing zone (2.3) of the sole (2) by means of end notches (2.14) to enhance their cushioning effect.

26. A sole according to claim 18, wherein the protuberances (2.1) are interrupted, along their length, by at least an intermediate notch (2.13), and/or are separated from a gluing zone (2.3) of the sole (2) by means of end notches (2.14) to enhance their cushioning effect.

27. A sole according to claim 19, wherein the protuberances (2.1) are interrupted, along their length, by at least an intermediate notch (2.13), and/or are separated from a gluing zone (2.3) of the sole (2) by means of end notches (2.14) to enhance their cushioning effect.

28. A sole according to claim 20, wherein the protuberances (2.1) are interrupted, along their length, by at least an intermediate notch (2.13), and/or are separated from a gluing zone (2.3) of the sole (2) by means of end notches (2.14) to enhance their cushioning effect.
